(19) United States
(12) Patent Application Publication
(10) Pub. No.: US 2013/0298848 A1
(43) Pub. Date: Nov. 14, 2013

(54) GAS FLOW MODULATOR AND METHOD FOR REGULATING GAS FLOW

(71) Applicant: GIRARD SYSTEMS, San Clemente, CA (US)

(72) Inventors: Franco Consadori, San Clemente, CA (US); Oscar Solis Marquez, San Juan Capistrano, CA (US)

(73) Assignee: GIRARD SYSTEMS, San Clemente, CA (US)

(21) Appl. No.: 13/891,539

(22) Filed: May 10, 2013

Related U.S. Application Data
(60) Provisional application No. 61/646,805, filed on May 14, 2012.

(51) Int. Cl. F24H 9/20; F16K 31/06

(52) U.S. Cl. CPC F24H 9/2035; F16K 31/0644
USPC 122/14.2; 251/129.04

(57) ABSTRACT

A gas flow modulator for gas appliances has electronic control to regulate the flow of gas by means of a control mechanism. The control mechanism is situated transversely to the flow of gas. The control mechanism also includes features to insure a minimal flow of gas and a maximum flow of gas as selectable by a potentiometer.

### CROSS-REFERENCE TO RELATED APPLICATION(S)

This is a regular utility application of and claims priority to U.S. Provisional Application No. 61/646,805, filed on May 14, 2012, the contents of which are expressly incorporated herein by reference.

### FIELD OF ART

The present disclosure is directed to an apparatus, systems, and methods for modulating gas flow. More particularly, the present disclosure describes an apparatus, systems, and methods for controlling the flow of combustible gas for commercial, residential and recreation heating applications.

### BACKGROUND

In the design and manufacture of gas appliances such as furnaces, water heaters, fireplaces and other such appliances, it is often desirable to be able to regulate the flow of a gas supply to a burner or other ignition source. By regulating the gas flow, the desired operating parameter of the appliance can be regulated, e.g. water temperature, heat output, etc.

Binary gas flow restrictors have the limitation that either the gas is on or off. Thus, dynamic temperature control results in unwanted temperature extremes at the heat exchanger or burner. Mechanically adjustable valves lack the automated adjustability and/or programmability of electrically controlled systems. Electrically controlled valves may also have limitations in size, complexity and therefore costs, and orientation of the control mechanism relative to the fuel flow path.

### SUMMARY

One embodiment of the present disclosure includes a system for modulating gas flow. The system includes a fuel supply, a regulator coupled to the fuel supply; a gas flow valve, the gas flow valve having a valve body having a fuel flow path, a control aperture, and a control mechanism partially disposed within the control aperture. The control mechanism has a shaft and a sleeve disposed and movable within the shaft and in communication with the fuel flow path. The system also includes a burner coupled to the gas flow valve. The control mechanism is disposed transversely to the fuel flow path.

Another aspect of the present disclosure includes a gas flow modulator. The gas flow modulator has a gas flow modulator valve. The gas flow modulator valve includes a valve body having a fuel flow path and a control aperture. The gas flow modulator valve further includes a control mechanism partially disposed within the control aperture. The control mechanism has a shaft and a sleeve disposed and movable within the shaft and in communication with the fuel flow path. The control mechanism is disposed transversely to the fuel flow path.

A method for modulating gas flow is described within the present disclosure. The method provides for a gas flow modulator valve having a fuel flow path defined by a gas inlet, a gas outlet. and a control aperture. The method partially disposes a control mechanism in the control aperture. The control mechanism has a shaft and a sleeve disposed and movable within the shaft and in communication with the fuel flow path. The control mechanism is disposed transversely to the fuel flow path. The method further contemplates coupling a potentiometer to the modulator valve, coupling the gas inlet to a gas supply; and coupling the gas outlet to a gas appliance.

### BRIEF DESCRIPTION OF THE DRAWINGS

These and other features and advantages of the present device, systems, and methods will become appreciated as the same become better understood with reference to the specification, claims and appended drawings wherein:

FIG. 1 illustrates a system level block diagram in accordance with one embodiment of the present disclosure;

FIG. 2 illustrates a perspective view of a gas flow modulator according to one embodiment of the present disclosure;

FIG. 3 illustrates an exploded view of the various components of the gas flow modulator of FIG. 2;

FIG. 4 illustrates a cross section view of a gas flow modulator according to one embodiment of the present disclosure; and

FIG. 5 illustrates another cross section view of a gas flow modulator according to one embodiment of the present disclosure.

### DETAILED DESCRIPTION

The detailed description set forth below in connection with the appended drawings is intended as a description of the presently preferred embodiments of a gas flow modulator provided in accordance with aspects of the present device, system, and method and is not intended to represent the only forms in which the present device, system, and method may be constructed or utilized. The description sets forth the features and the steps for constructing and using the embodiments of the present device, system, and method in connection with the illustrated embodiments. It is to be understood, however, that the same or equivalent functions and structures may be accomplished by different embodiments that are also intended to be encompassed within the spirit and scope of the present disclosure. As denoted elsewhere herein, like reference numerals are intended to indicate like or similar elements or features.

FIG. 1 is a system level block diagram showing a gas system 100 in accordance with an embodiment of the present disclosure. As shown, a gas supply 101 is connected to a burner 105 for supplying fuel to the burner. The gas supply 101 may be any type of combustible gas fuel, such as natural gas or propane. In the present embodiment, the gas supply 101 is contemplated as liquid propane (LP). The liquid propane may be stored in one or more tanks. Each tank may have a specific capacity. For example, conventional LP tanks for personal, residential and/or recreational use may have a capacity of 5 gallons. However, other size tanks, including tanks for commercial purposes, are contemplated and are within the scope of this disclosure.

The gas system 101 includes a regulator 103. In the present embodiment, the regulator 103 causes the liquid propane stored in the tank 101 to change from a liquid state to a gaseous state due to pressure drop across the regulator so that the gas may be combusted by an appliance such as a water heater, furnace, gas fireplace or other type of gas appliance. The regulator may also include a shut off valve (shown schematically by reference numeral 103 and typically a separate valve body apart from the regulator 103). In the event that there is a gas leak in the system, or for any other user requirement, the shut off valve stops the flow of gas from the gas supply 101. Thus, the shut off valve serves to isolate the gas supply 101 from the remainder of the system 100.

In another embodiment, a failed close solenoid valve (not shown) is located immediately downstream of the regulator 103. i.e., further away from the gas source. In the event of an electrical or power failure, the failed close solenoid valve closes the gas line 120 to the burner 105. The failed close solenoid valve is either fully opened when powered or fully closed when power is lost.

In the present embodiment, a gas flow modulator 200 includes a potentiometer (P) 201 or other type of electrical/electronic control, a controller 202 and a modulator valve 203. The modulator valve 203 is coupled to the regulator 103 and to the controller 202. The controller is also coupled to the potentiometer 201. The modulator valve 203 serves to control the volume of gas, i.e. the fuel flow, distributed to the burner 105. The function and components comprising the modulator valve 203 are more fully described below.

In one example, the potentiometer 201 is a linear potentiometer, a membrane potentiometer, a single-turn potentiometer, or a multi-turn potentiometer. An output of the potentiometer 201 is connected to the controller 202. The controller 202 receives input from the potentiometer 201 and provides the operating output voltage range for proper operation of the modulator valve 203, such as in the range of 3-9 volts to modulate the magnetic flux of the solenoid, as further discussed below. The controller 202 may also include a time delay circuit, thereby allowing for a delay in outputting signals to the modulator valve 203 to delay restricting the flow of gas to the burner 105. That is, during the time delay period, there is no power distributed to the modulator valve 203. Without power, the modulator valve 203 is in a full open state with maximum gas flow, as further described below in reference to FIG. 5. The full open state facilitates proper lighting of the burner 105. The controller 202 may also be coupled to a feedback loop from, for example a water temperature sensor, so as to maintain a constant water temperature by adjusting gas flow, via modulating the valve 203, in real time. Feedback loops having other parameters between the controller 202 and the appliance are also contemplated as being within the scope of the disclosure.

Also illustrated in FIG. 1 is a burner 105, which can embody any number of prior art burners, with or without manual flow control or regulator for modulating flow to the burner. The burner 105 receives the gas flow from the gas supply through the modulator valve 203 and combusts the gas to produce heat. The burner 105 may be connected to or part of a gas appliance such as a hot water heater or other gas appliance. The burner 105 may also include a pilot light. The pilot light serves as an ignition source to ignite the burner 105 when the flow of gas is turned on. The pilot light uses a relative small volume of gas and is therefore left burning continuously as long as the gas supply is connected and available. Alternatively, a spark or electronic igniter may be incorporated at the burner for providing the needed spark to light the fire.

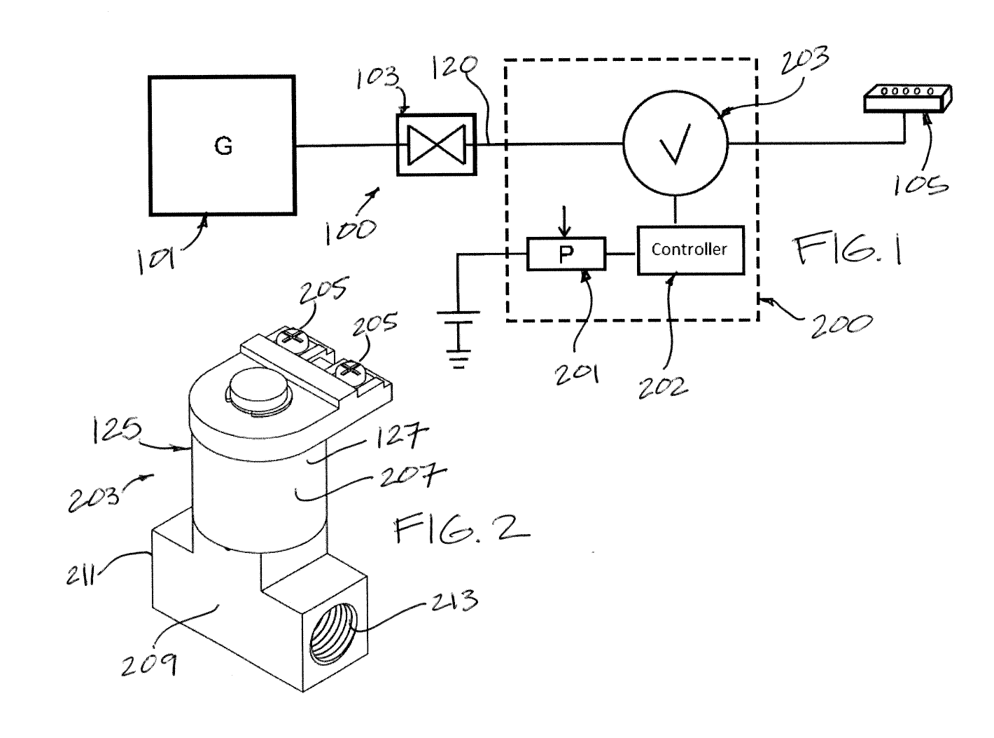

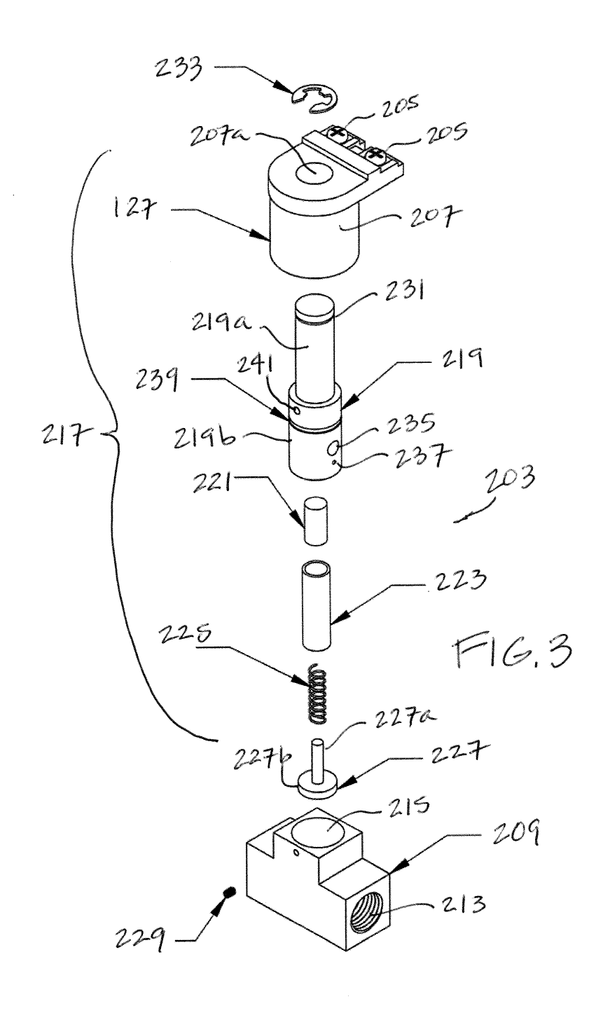

Referring to FIG. 2, a perspective view of the modulator valve 203 is illustrated comprising a solenoid 125 and a valve body 209. Terminals 205 are provided on the solenoid body 127. The terminals are electrical contacts that connect the modulator valve 203 to the potentiometer 201 by one or more wires (shown schematically in FIG. 1). The terminals 205 are also connected to coil or coil windings 207 located inside the solenoid body 127. The coil 207 acts as an electro-magnet to move a shaft located therein and its function as part of a control mechanism is more fully described below. By varying internal resistance, the potentiometer 201 controls the voltage potential and current to the coil 207 to change the magnetic flux produced by the coil and hence the amount of travel of the shaft against a spring force, as further discussed below.

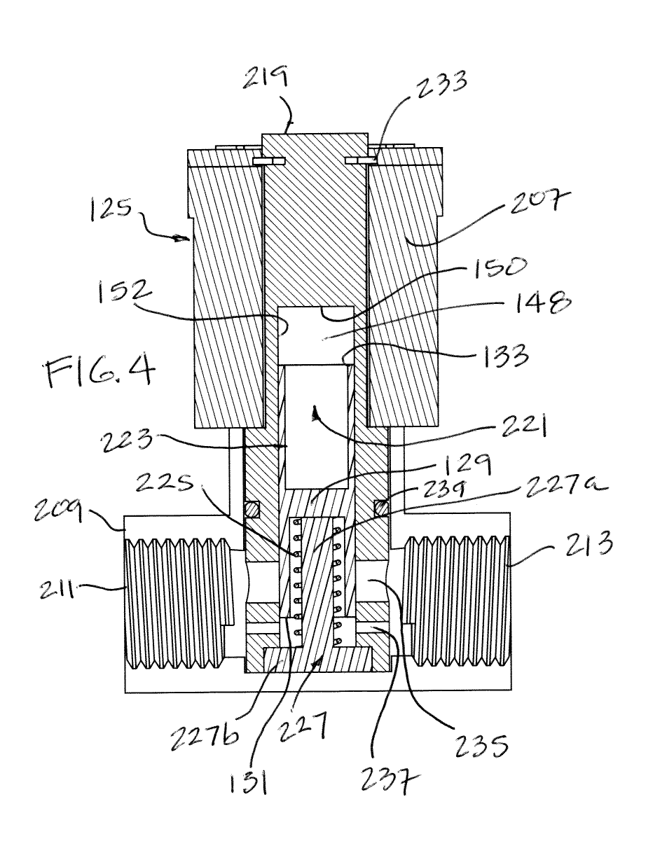

A modulator valve body 209 is coupled to the solenoid 125. The modulator valve body 209 is formed from a metallic material. In one example, the metallic material is non-corrosive and non-magnetic material, such as brass. In another example, the valve body is formed from engineered plastic, such as polyetheretherketone (PEEK). The valve body 209 has a basic “T” shape having a horizontal member and a vertical member although other body configurations are contemplated. The horizontal member includes a gas inlet 211 disposed on one end and a gas outlet 213 disposed on an opposite end. The vertical member, which is substantially perpendicular to the horizontal member, has a control aperture 215 (shown in FIG. 3). Although described as having a “T” shape with horizontal and vertical members, in the present embodiment the valve body 209 is an integral structure fabricated from a homogeneous material.

The gas inlet 211 and gas outlet 213 provide a fuel flow path for the gas as it passes through the modulator valve body 209. The gas inlet 211 and gas outlet 213 may have threaded apertures, female threads, for threadedly connecting with gas lines. Alternatively, the gas inlet 211 and gas outlet 213 may be protrusions such as male nipples having threads circumferentially around the exterior of the nipples (not shown. i.e., male threads). The transverse coupling of the modulator valve body 209 to the solenoid 125 allows for the gas to flow laterally through the modulator valve body 209, while the solenoid 125 and thus the control mechanism 217 (see FIG. 3) is coupled longitudinally to the modulator valve body 209. That is, the control mechanism 217 is transverse, e.g. substantially orthogonal, to the flow of gas.

An exploded or disassembled view of the gas flow modulator 203 is illustrated in FIG. 3. The control mechanism 217 of the solenoid 125 is comprised of the coil or coil windings 207 located inside the solenoid body 157, a shaft 219, a magnet 221 located at one end of an elongated sleeve 223, a spring 225 located at a second end of the elongated sleeve 225, and a spring pin 227 having a pin portion 227a that is inserted into an inner circumference of the spring 225 and a base portion 227b. In one example, the base portion 227b is inserted into an inner circumference of the shaft 219. In another example, the base portion is positioned in the valve body but externally of the shaft. When inserted, a lower surface of the base portion 227b is substantially coplanar with a lower surface of a lower opening of the shaft 219. The sleeve 223 and spring pin 227 may be formed from a plastic material or other non-magnetic, non-corrosive materials.

The magnet 221 is disposed in an upper portion of the hollow cylinder sleeve 223, which may be referred to as a first end of the sleeve. In one example, the magnet 221 is pressed fit into the sleeve 223. In another example, the magnet is bonded or glued to the first end of the sleeve. The spring 225 and the spring pin 227 are inserted into a lower portion of the hollow cylinder sleeve 223. The magnet 221 and the spring 225 may be separated by a partition 129 formed internally of the sleeve 223. In one example, the partition 129 is located half-way between the first end and the second end of the sleeve 223. In another example, the partition is located closer to the first end than the second end of the sleeve to provide greater volume or space for the compartment with the spring, such as to provide more spring space for spring travel and compression. Alternatively, the magnet 221 maybe pressed fit into the sleeve and the spring 225 may contact a lower surface of the magnet 221 without the partition 129. The sleeve 223 is disposed internal to the shaft 219. The shaft 219 and sleeve 223 assembly (i.e. magnet 221, spring 225 and spring pin 227, or at least portions thereof) are coupled to the modulator valve body by a set screw 229. A lower portion of the shaft 219 is inserted into the control aperture 215 of the valve body. Thus, the control mechanism 217 is partially inserted into the valve body 209 via the control aperture 215.

The shaft 219 may be a two-tiered cylindrical, homogeneous, integral structure. The shaft 219 may be formed from a non-corrosive, non-magnetic material such as brass. The two tiers may be homogeneous in material. The two tiers may also be integral in that they may be forged or cast simultaneously. In alternative embodiments, the two tiers may be neither homogeneous nor integral, i.e. two separate components formed separately from different materials and coupled together.

The two tiers include an upper tier 219a having an outer circumference and a cylindrical hollow interior and a lower tier 219b having an outer circumference, which is greater than the outer circumference of the upper tier 219a. The lower tier 219b also has a cylindrical hollow interior which has a circumference that is substantially the same as the cylindrical hollow interior of the upper tier 219a. Thus, as shown, it is understood that the shaft comprises an first section having a first outer diameter and a second section having a second outer diameter that is greater than the first diameter, and wherein the shaft comprises an inner bore having a generally constant inside diameter.

The shaft 219 has several other features which are illustrated in the present embodiment. Located on the upper tier 219a is an annular recess 231 that permits the shaft 219 to be connected to the coil 207 by a retainer ring 233. That is, the shaft 219 is inserted into the solenoid body 127 until the first tier section projects through an opening 207a in the solenoid body 127 and the retainer ring 233 is fitted into the annular recess 231 to secure the shaft 219 to the solenoid body 127. In another example, a threaded cap or nut is threaded to the first end of the shaft that projects out the opening 207a.

The lower tier 219b of the shaft 219 has a number of openings. A first set of openings includes two circular openings 235 of the same size (i.e. same radius) which are diametrically opposed to each other across the cylindrical hollow interior of the lower tier 219b of the shaft 219. A second set of openings includes two circular openings 237 also of the same size (i.e. same radius) which are also diametrically opposed to each other across the cylindrical hollow interior of the lower tier 219h of the shaft 219. In the present embodiment, the radius of the second set of openings is substantially smaller than the radius of the first set of openings. Preferably the first set of openings 235 is located further away from the open end of the lower tier 219b than the second set of openings 237. In an alternative embodiment, each set of openings can have more than two holes or more than two circular openings. In still yet another embodiment, only the first set of openings 235 can have more than two circular openings. Although the openings of each set are of the same size, they can vary and can have a different configuration than circular, such as oval or star shape.

The lower tier 219b of the shaft 219 also includes an O-ring 239 located exteriorly of the shaft 219 and which may be partially recessed, such as by incorporating an annular groove for receiving the O-ring. The O-ring 239 provides a seal against the interior surface of the valve body when the shaft 219 is inserted into the modulator valve body 209 such that when gas flows through the modulator valve body 209, leaks are avoided or prevented. Also, the lower tier 219b of the shaft 219 may include a threaded bore 241 for receiving the set screw 229. In some embodiments the threaded bore 241 may be threaded to match the threads of the set screw 229.

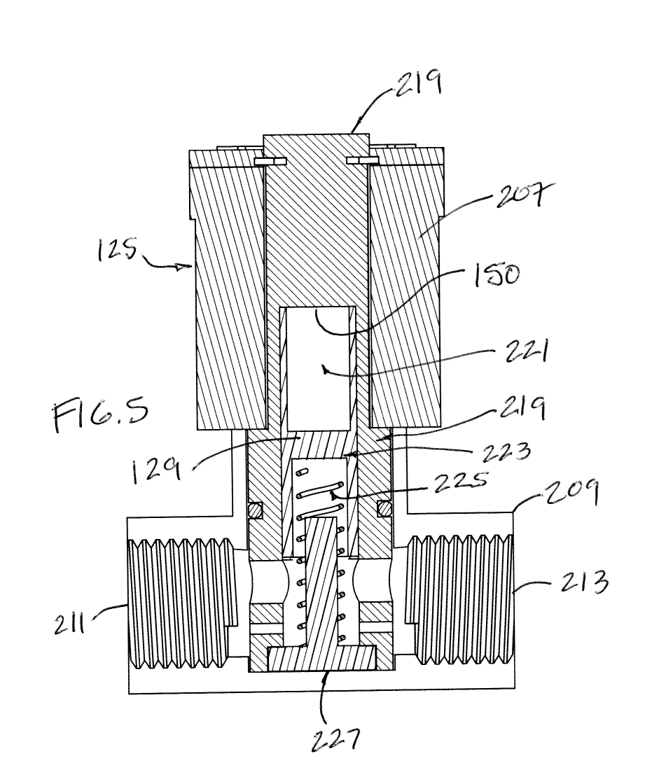

The operation of the gas flow modulator valve 203 can best be appreciated by referring to FIGS. 4 and 5. FIG. 4 is a cross sectional view of one embodiment of the present disclosure illustrating the position of the valve 203 for minimum gas flow. Note that the two diametrically opposed sets of openings include the upper set 235 and the lower set 237 and that the upper set of openings 235 are substantially larger than the lower set of openings 237. In one example, at least one of the circular openings of the upper set of openings is at least 30% larger than the lower set of openings. In another example, at least one of the circular openings of the upper set of openings is at least 200% larger than the lower set of openings. Preferably, at least one of the circular openings of the upper set of openings is at least 300% larger to about 600% larger than the lower set of openings with larger sizes contemplated. In embodiment shown, the upper set of openings 235, when modulated, provides for gas flow through the valve 203 to the burner 105 (FIG. 1) for operation of the appliance, such as a stove, a water tank, or other fuel consuming equipment. The circular openings of the first set or upper set of openings 235 may be wide open to permit maximum flow through the valve body, closed or occluded to restrict flow or block flow through the upper set of openings 235, or modulated to permit partial flow somewhere in between. The second set or lower set of openings 237, because they are not blocked or closed by the sleeve 223 even in the minimum gas flow condition, only allows for a small volume of gas there across to maintain the pilot light at the burner 105 and/or to maintain a low flame at the burner.

As shown in the minimum gas flow condition of FIG. 4, the spring 225 is compressed by the electro-magnetic force applied from the coil 207 as determined by the position of the potentiometer (FIG. 1), which forces the sleeve 223 downward. A lateral surface of the sleeve, such as the sleeve body, obstructs, blocks or otherwise restricts the flow of gas through the upper set of openings 235. However, because of the length of the pin portion 227a relative to the position of the magnet 221 in the sleeve 223 (or a partition internal to the sleeve 223 which separates the magnet 221 from the spring 225), the sleeve is prevented from blocking or restricting the flow of gas through the lower set of openings 237. Thus, even in the fully energized position shown in FIG. 4, when the potentiometer 201 is set for minimal gas flow, a minimal flow of gas to maintain the pilot light or for other considerations is preserved.

Thus, as shown, the modulator valve 203 is understood to include a valve body 209 comprising an inlet 211, an outlet 213, and an intermediate opening 215 in communication with a body bore 215 having a bore bottom. A shaft 219 comprising an elongated body having at least one end opening, a hollow core, a first set of openings 235 each with an opening dimension, and a second set of openings 237 each with an opening dimension positioned in the body bore of the valve body. A sleeve 223 comprising a magnet 221 concentrically positioned and axially movable relative to the shaft is positioned at least partially within the shaft. A spring 225 is provided in the shaft for biasing the sleeve away from the bore bottom of the body bore. A solenoid 125 comprising coil windings is coupled to the valve body for moving the magnet towards the bore bottom when actuated. In a particular example, a spring pin 227 is positioned inside a central space of the spring. The spring pin comprises a pin portion 227a and a base portion 227b. The pin portion 227a has a length and an end in contact with a partition surface inside the bore of the sleeve or a contact end surface of the magnet. In an example, the length of the pin portion 227a is longer than a distance between the partition surface and the end most surface 131 of the sleeve 131 (FIG. 4) or longer than a distance between the contact end of the magnet and the end most surface of the sleeve 131 so that the portion of the sleeve below the partition surface or below the contact surface of the magnet does not completely cover the pin portion 227a. This allows the lower or second set of openings 237 to be free from obstructions to permit minimal gas flow through the valve. In an alternative embodiment, the sleeve is longer, or the spring pin stem 227a is shorter, so that the end 131 of the sleeve 223 contacts the base 227b of the spring pin 227 in the minimum flow position. However, the sleeve 223 incorporates a corresponding set of openings (not shown) that align with the lower openings 237 on the shaft 219 to permit flow through the shaft and the corresponding openings on the sleeve.

In still yet another example, the locations of the minimum flow openings 237 and the large flow openings 237 may be reversed, with the minimum flow openings 237 located above the large flow openings 235. In this alternative embodiment, the sleeve incorporates a corresponding set of openings as the re-arranged minimum flow openings.

Referring to FIG. 5, operation of the gas modulator valve 203 for maximum gas flow is illustrated. In this embodiment, the electro-magnetic force is minimized, removed, or turned off from the coil 207. In the absence of the electro-magnetic force, the spring 225 expands to push the sleeve 223 upwards towards the retainer ring 233 thus revealing the upper set of openings 235 (as well as the lower set of openings 237) and allowing the maximum volume of gas to pass through the valve body 209. Note that when power is lost to the gas flow modulator 200 (i.e. to the potentiometer 201 and the coil 207, See FIGS. 1-3), this has the effect of removing the electro-magnetic force and the gas modulator valve 203 reverts to the open or maximum flow state. Also, if the regulator 103 shut off valve is closed (see FIG. 1) and the gas modulator valve is placed in the maximum gas flow state, any trapped gas in the system 100 will vacate the system and insure that there is no pent up gas pressure in the lines that may otherwise cause a safety hazard.

With reference again to FIG. 4, the shaft 219 has a bore 148 comprising a bore bottom 150 for receiving the sleeve 223, as previously discussed. The gap 152 between the upper end 133 of the sleeve 223 and the bore bottom 150 of the shaft 219 represents the maximum range of travel for the sleeve within the bore 148. Thus, depending on the position of the potentiometer P (FIG. 1), the upper end 133 of the sleeve can rise a small amount to a maximum amount, represented by the upper end 133 abutting or contacting the bore bottom 150, as shown in FIG. 5 and depending on the length and size of the spring 225.

Thus, as described, the modulator valve 203 is understood to include a valve body 209 comprising an inlet 211, an outlet 213, and an intermediate opening 215 in communication with a body bore 215 having a bore bottom. A shaft 219 comprising an elongated body having at least one end opening, a hollow core, a first set of openings 235 and a second set of openings 237 positioned in the body bore of the valve body. A sleeve 223 comprising a magnet 221 concentrically positioned and axially movable relative to the shaft is positioned at least partially within the shaft. A spring 225 is provided in the shaft for biasing the sleeve away from the bore bottom of the body bore. A solenoid 125 comprising coil windings is coupled to the valve body for moving the magnet towards the bore bottom when actuated. When the potentiometer is rotated, the solenoid reacts and changes the magnetic flux inside the valve, which allows the spring to move from a fully compressed position to a less compressed position. Thus, in the present valve embodiment, it is the sleeve that moves and not the shaft to control the amount of gas flow through the valve. In a particular example, the shaft is secured to the solenoid by a mechanical fastening device, such as a clip.

In a particular example, a spring pin 227 is positioned inside a central space of the spring. The spring pin comprises a pin portion 227a and a base portion 227b. The pin portion 227a has a length and an end in contact with a partition surface inside the bore of the sleeve or a contact end surface of the magnet. In an example, the length of the pin portion 227a is longer than a distance between the partition surface and the end most surface 131 of the sleeve 131 (FIG. 4) or longer than a distance between the contact end of the magnet and the end most surface of the sleeve 131 so that the portion of the sleeve below the partition surface or below the contact surface of the magnet does not completely cover the pin portion 227a.

Although limited embodiments of the gas flow modulator assemblies and their components have been specifically described and illustrated herein, many modifications and variations will be apparent to those skilled in the art. Accordingly, it is to be understood that the gas flow modulator assemblies and their components constructed according to principles of the disclosed device, system, and method may be embodied other than as specifically described herein. The disclosure is also defined in the following claims.

What is claimed is:

1. A system for modulating gas flow, comprising:
a fuel supply;
a regulator coupled to the fuel supply;
a gas flow valve coupled to the regulator, the gas flow valve comprising a valve body having a fuel flow path, a control aperture, and a control mechanism partially disposed within the control aperture; said control mechanism having a shaft and a sleeve disposed and movable within the shaft and in communication with the fuel flow path;
a burner coupled to the gas flow valve; and
wherein the control mechanism is disposed transversely to the fuel flow path.

2. The system of claim 1, wherein the fuel flow path includes a first set of openings having a first diameter and a second set of openings having a second diameter.

3. The system of claim 2, wherein the first diameter is unequal to the second diameter.

4. The system of claim 1, wherein the burner is coupled to a gas appliance.

5. The system of claim 1, wherein the sleeve axially movable relative to the shaft to partially, but not completely, obstruct the fuel flow path.

6. The system of claim 1, further comprising a solenoid comprising coil, a magnet disposed within the sleeve, and a spring disposed within the sleeve; wherein the coil produces an electro-magnetic force to move the magnet and therefore sleeve to compress the spring.

7. The system of claim 1, further comprising a controller electrically coupled to the control mechanism on the gas flow valve.

8. A gas flow modulator, comprising:
a gas flow modulator valve comprising a valve body having a fuel flow path and a control aperture; the gas flow modulator valve further including a control mechanism partially disposed within the control aperture: the control mechanism having a shaft and a sleeve disposed and movable within the shaft and in communication with the fuel flow path; wherein the control mechanism is disposed transversely to the fuel flow path.

9. The modulator of claim 8, wherein the fuel flow path includes a first set of openings having a first diameter and a second set of openings having a second diameter.

10. The modulator of claim 9, wherein the first diameter is unequal to the second diameter.

11. The modulator of claim 8, wherein the modulator is coupled to a water heater.

12. The modulator of claim 8, wherein the sleeve may axially movable inside a bore of the shaft to partially, but not completely, obstruct the fuel flow path.

13. The modulator of claim 8, wherein the control mechanism further comprises a coil and a magnet disposed within the sleeve and the coil produces an electro-magnetic force to move the magnet and therefore the sleeve within the shaft.

14. The modulator of claim 8, wherein the transverse disposition of the control mechanism relative to the fuel flow path is substantially orthogonal.

15. A method for modulating gas flow, comprising:
providing a gas flow modulator valve having a fuel flow path defined by a gas inlet, a gas outlet, and a control aperture;
partially disposing a control mechanism in the control aperture, the control mechanism having a shaft and a sleeve disposed and movable within the shaft and in communication with the fuel flow path, wherein the control mechanism is disposed transversely to the fuel flow path;
coupling a potentiometer to the modulator valve;
coupling the gas inlet to a gas supply; and
coupling the gas outlet to a gas appliance.

16. The method of claim 15, further providing a first set of openings having a first diameter and a second set of openings having a second diameter in the fuel flow path.

17. The method of claim 16, wherein the first diameter is unequal to the second diameter.

18. The method of claim 16, further comprising moving the sleeve to obstruct the first set of openings but not the second set of openings.

19. The method of claim 16, further comprising moving the sleeve such that a lateral surface of the sleeve obstructs the first set of openings.

20. The method of claim 16, further providing a spring disposed within the sleeve, wherein movement of the sleeve causes compression of the spring.
